(19) United States
(12) Patent Application Publication
(10) Pub. No.: US 2007/0053544 A1
(43) Pub. Date: Mar. 8, 2007

(54) Wireless headphone

(75) Inventors: Yun-Long Jhao, Taipei Hsien (TW); Yu-Ci Wang, Taipei Hsien (TW); Jhen-Bang Chen, Taipei Hsien (TW); Jheng-Jhe Cai, Taipei Hsien (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: KYE Systems Corporation

(21) Appl. No.: 11/263,959

(22) Filed: Nov. 2, 2005

(30) Foreign Application Priority Data
Sep. 2, 2005 (TW) 094130136

(51) Int. Cl. H04R 25/00

(52) U.S. Cl. 381/384

(57) ABSTRACT

A wireless headphone, which includes a headband, two housings fixedly fastened to the ends of the headband, an electric connector mounted in an insertion slot in one housing, two speakers respectively mounted in the housings and electrically coupled to the electric connector in the insertion slot, a microphone electrically coupled to the electric connector in the insertion slot, and a sound source insertable into the insertion slot and electrically connected to the electric connector in the insertion slot for outputting an audio signal to the speakers for output and transmitting the voice signal picked up by the microphone to a wireless communication apparatus through a wireless transmission.

### BACKGROUND OF THE INVENTION

1. Field of the Invention

The present invention relates to headphones and more particularly, to a wireless headphone, which has an insertion slot in one housing at one end of the headband thereof for receiving a sound source, for example, iPOD™ Shuffle™ MP3 player, Bluetooth stereo headset, Bluetooth stereo transceiver, radio, etc., to electrically couple the inserted sound source to the speakers at the ends of the headband.

2. Description of the Related Art

A Bluetooth headset (headphone) has a Bluetooth transmission module for communication between the speakers and microphone of the Bluetooth headset and a Bluetooth cellular telephone.

Further, when using a headphone to listen to a radio or MP3 player, for example, Apple™'s iPOD™ Shuffle™ MP3 player, the user needs to connect the earphone plug cable to the earphone jack of the radio or MP3 player. The earphone plug cable may hinder the user's movement.

### SUMMARY OF THE INVENTION

The present invention has been accomplished under the circumstances in view. It is therefore the main object of the present invention to provide a wireless headphone, which can be used with any of a variety of sound sources without cable. The sound source can be an iPOD™ Shuffle™ MP3 player, Bluetooth stereo headset, Bluetooth stereo transceiver, radio, etc. that can output an audio signal and/or receive an audio signal.

To achieve this and other objects of the present invention, the wireless headphone comprises a headband, two housings fixedly fastened to the ends of the headband, an electric connector mounted in an insertion slot in one housing, two speakers respectively mounted in the housings and electrically coupled to the electric connector in the insertion slot, a microphone electrically coupled to the electric connector in the insertion slot, and a sound source insertable into the insertion slot and electrically connected to the electric connector in the insertion slot for outputting an audio signal to the speakers for output and transmitting the voice signal picked up by the microphone to a wireless communication apparatus through a wireless transmission.

### BRIEF DESCRIPTION OF THE DRAWINGS

FIG. 1 is a schematic perspective view showing a wireless headphone used with a Bluetooth stereo transceiver according to the present invention.

FIG. 2 is a schematic perspective view showing a wireless headphone used with a MP3 player according to the present invention.

FIG. 3 is a schematic drawing showing a wireless headphone used with a Bluetooth stereo transceiver in communication with a Bluetooth cellular telephone according to the present invention.

FIG. 4 is a schematic drawing showing a wireless headphone provided with a battery case and a power switch and used a Bluetooth stereo transceiver in communication with a Bluetooth cellular telephone according to the present invention.

FIG. 5 is a schematic drawing showing a wireless headphone used with a MP3 player according to the present invention.

FIG. 6 is a schematic drawing showing a wireless headphone provided with a battery case and a power switch and used a MP3 player according to the present invention.

### DETAILED DESCRIPTION OF THE PREFERRED EMBODIMENT

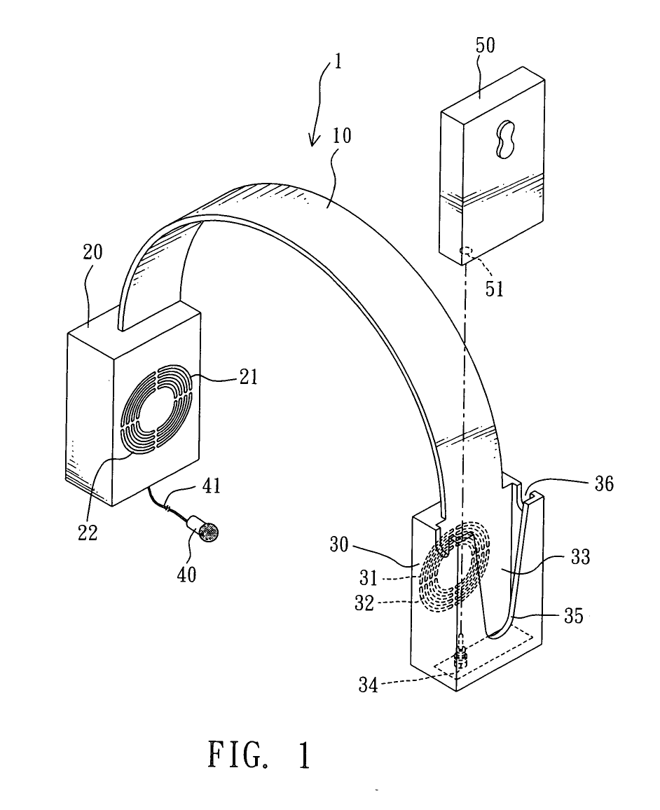

Referring to FIG. 1, a wireless headphone 1 in accordance with the present invention is shown comprised of a headband 10, a first housing 20, a second housing 30, a microphone 40, and a sound source 50.

The headband 10 is made of, for example, plastics, in, for example, an arched shape suitable for attaching to the user's head or neck.

The first housing 20 is fixedly fastened to one end of the headband 10, having a speaker 21 mounted on the inside and facing the other end of the headband 10, and a grille 22 covering the speaker 21 for output of sound waves produced by the speaker 21.

The second housing 30 is fixedly fastened to the other end of the headband 10, having a speaker 31 mounted on the inside and facing the first housing 20, a grille 32 covering the speaker 31 for output of sound waves produced by the speaker 31, an upwardly extending insertion slot 33 adapted to accommodate the sound source 50, an electric connector 34 fixedly mounted inside the insertion slot 31 and electrically coupled to the speaker 21 in the first housing 20 and the speaker 31 in the second housing 30, a V-shaped opening 35 formed in the peripheral wall in communication with the insertion slot 33 at an outer side, and two finger notches 36 formed in the top wall at two sides of the insertion slot 31 through which the user can insert the fingers into the insertion slot 31 from two opposite sides to remove the sound source 50 out of the insertion slot 33.

The microphone 40 has an extension arm 41 fastened to, for example, the first housing 20, and is electrically coupled to the connector 34 in the second housing 30 for picking up the user's voices.

The sound source 50 is insertable into the insertion slot 33 of the second housing 30, having an electric connector 51 connectable to the electric connector 34 in the insertion slot 33 of the second housing 30. The sound source 50 can be an iPOD™ Shuffle™ MP3 player, Bluetooth stereo headset, Bluetooth stereo transceiver, radio, etc. that can output an audio signal and/or receive an audio signal.

Further, the connection between the electric connector 34 in the insertion slot 33 and the electric connector 51 of the sound source 50 can be done through a physical connection, or a non-physical connection. The physical connection can be achieved in such a manner that the electric connector 51 is made in the form of an earphone jack and the electric connector 34 is made in the form of an earphone plug. Alternatively, the electric connectors 34 and 51 can be a male USB connector and a female USB connector. The non-physical connection can be achieved by means of magnetic induction or wireless transmission. The wireless transmission can be infrared transmission or radio frequency transmission. FIG. 1 shows an example of the physical connection. FIG. 7 shows an example of the non-physical connection.

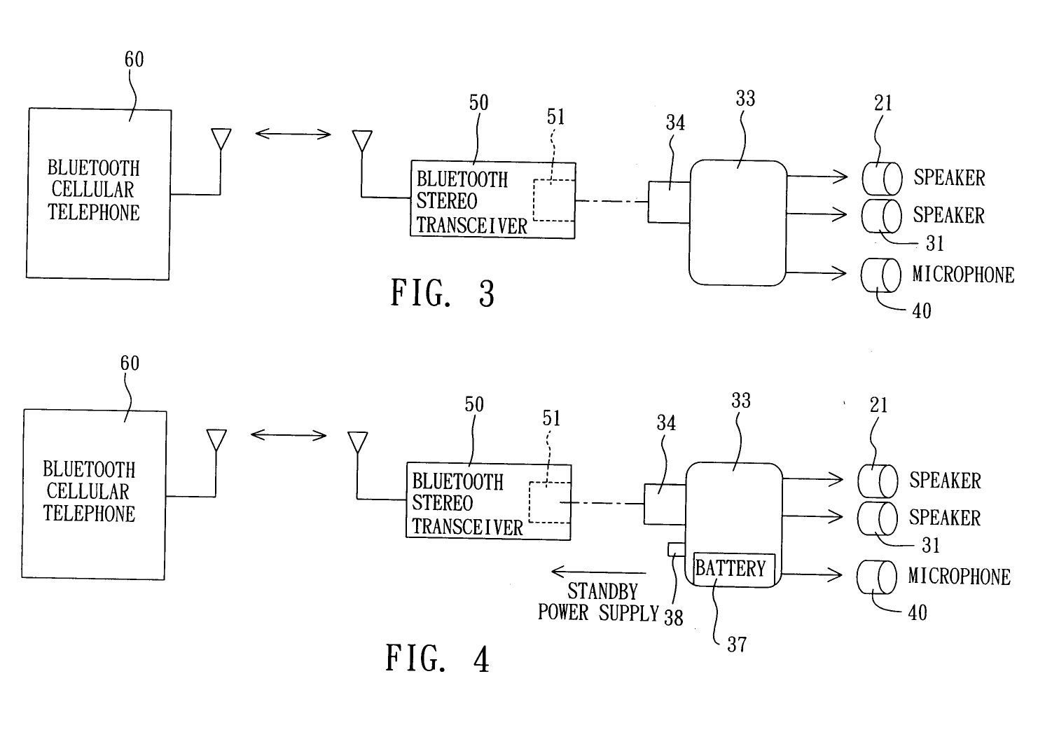

According to the embodiment shown in FIG. 1, the sound source 50 is a Bluetooth stereo transceiver; the electric connector 51 is an earphone jack; the electric connector 34 is an earphone plug. After insertion of the sound source 50 into the insertion slot 33, the electric connector (earphone jack) 51 of the sound source 50 is connected to the electric connector (earphone plug) 34. At this time, the voice signal received by the microphone 40 can be transmitted to a Bluetooth cellular telephone 60 through the sound source (Bluetooth stereo transceiver) 50 (see FIG. 3).

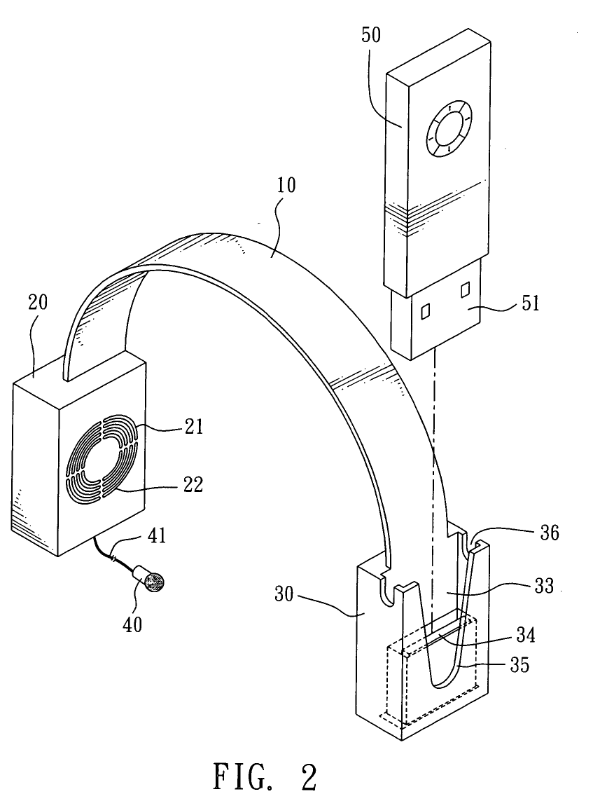

FIG. 2 shows an alternate form of the present invention. According to this embodiment, the sound source 50 is a MP3 player, and the electric connector 51 of the sound source 50 is a male USB connector. After insertion of the sound source (MP3 player) 50 into the insertion slot 33 of the second housing 30, the electric connector (male USB connector) 51 of the sound source (MP3 player) is electrically connected to the electric connector (female USB connector) 34 in the second housing 30. At this time, output audio signal of MP3 format is transmitted from the sound source (MP3 player) 50 through the electric connector (male USB connector) 51 of the sound source (MP3 player) and the electric connector (female USB connector) 34 to the speakers 21 and 31. Therefore, the user can listen to the music produced by the sound source (MP3 player) 50 when walking, jogging, dancing, or working.

In the aforesaid first and second embodiments, the housing 20 (30) and the speaker 21 (31) are fixedly fastened together. Alternatively, the speaker 21 (31) and the housing 20 (30) can be separated members. Further, the housing 20 can be made to accommodate a battery, i.e., the housing 20 can be made having a battery case 37 inside the insertion slot 33 for holding a battery (see FIGS. 4 and 6). Alternatively, the battery case 37 can be a detachable member detachably attached to the housing 20 or 30.

In the aforesaid first and second embodiments, there are two speakers 21 respectively installed in the first housing 20 and the second housing 30. Alternatively, the wireless headphone can be made having only one speaker. Further, the headband 10 can be made for fastening to the user's head, or the user's neck.

The battery case 37 can be formed in the first housing 20 or the second housing 30, and electrically coupled to the electric connector 34 to provide the necessary working voltage to the sound source 50. The battery case 37 can be made to accommodate AA or AAA primary battery, AA or AAA secondary battery, or Li-ion rechargeable battery.

The wireless headphone further comprises a power switch 38 electrically coupled to the battery case 37 and the electric connector 34 in the insertion slot 33 (see FIGS. 4 and 6). When the battery power of the sound source 50 is low, the user can switch on the power switch 38 to electrically connect the battery case 37 to the electric connector 34, enabling the battery in the battery case 37 to provide the necessary working voltage to the sound source 50. The power switch is preferably an auto-switching electronic switch. Further, the battery case 37 can be designed to have a charging circuit that automatically charges the battery of the sound source.

According to the embodiment shown in FIG. 3, the sound source 50 of the wireless headphone 1 is a Bluetooth stereo transceiver. After insertion of the Bluetooth stereo transceiver 50 into the insertion slot 33, the voice signal picked up by the microphone 40 is transmitted wirelessly to a wireless communication apparatus, for example, a Bluetooth cellular telephone 60 through the Bluetooth stereo transceiver 50, and the voice signal outputted from the Bluetooth cellular telephone 60 can be transmitted to the Bluetooth stereo transceiver 50 wirelessly and then transmitted from the Bluetooth stereo transceiver 50 to the first speaker 21 and the second speaker 31 through the electric connectors 51 and 34. Therefore, the user can talk to a person at a remote site through the Bluetooth stereo transceiver 50.

According to the embodiment shown in FIG. 4, the wireless headphone 1 is provided with a battery case 37 and a power switch 38, and the sound source 50 of the wireless headphone 1 is a Bluetooth stereo transceiver. When the battery power of the Bluetooth stereo transceiver 50 is low, the user can switch on the power switch 38 to electrically connect the battery case 37 to the Bluetooth stereo transceiver 50, enabling the battery in the battery case 37 to provide the necessary working voltage to the Bluetooth stereo transceiver 50. Further, the battery case 37 can be made having a charging circuit to charge the battery of the Bluetooth stereo transceiver 50.

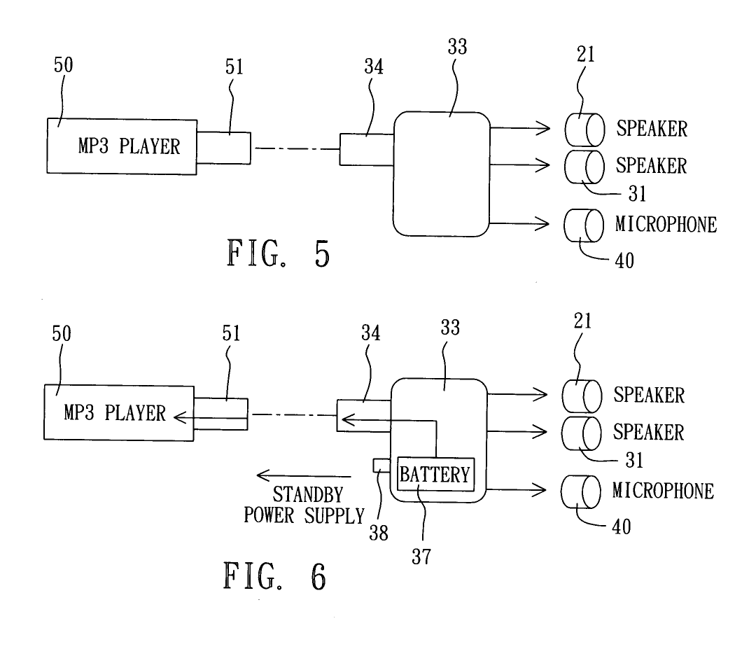

According to the embodiment shown in FIG. 5, the sound source 50 of the wireless headphone 1 is a MP3 player. After insertion of the MP3 player 50 into the insertion slot 33, the audio signal of MP3 format produced by the MP3 player 50 is transmitted through the electric connector 51 and the electric connector 34 to the first speaker 21 and the second speaker 31 for output. Thus, the user can listen to the music produced by the MP3 player 50 through the speakers 21 and 31 without the use of any cables.

According to the embodiment shown in FIG. 6, the wireless headphone 1 is provided with a battery case 37 and a power switch 38, and the sound source 50 of the wireless headphone 1 is a MP3 player. When the battery power of the MP3 player 50 is low, the user can switch on the power switch 38 to electrically connect the battery case 37 to the MP3 player 50, enabling the battery in the battery case 37 to provide the necessary working voltage to the MP3 player 50. Further, the battery case 37 can be made having a charging circuit to charge the battery of the MP3 player 50.

A prototype of wireless headphone has been constructed with the features of FIGS. 1˜6. The wireless headphone functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1-17. (canceled)

18. A wireless headphone comprising
a headband;
at least one speaker;
at least one housing coupled to said headband, one of said at least one housing having an insertion slot and an electric connector mounted inside said insertion slot and electrically coupled to said at least one speaker; and
a sound source received within said insertion slot and having an electric connector electrically connectable to the electric connector in said insertion slot such that said sound source transmits an audio signal to said at least one speaker.

19. The wireless headphone as claimed in claim 18, further comprising a microphone electrically coupled to the electric connector in said insertion slot and adapted to pick up a voice signal and to transmit said voice signal to said sound source.

20. The wireless headphone as claimed in claim 19, wherein said sound source wirelessly transmits said voice signal to a wireless communication apparatus.

21. The wireless headphone as claimed in claim 20, wherein said wireless communication apparatus is a cellular phone.

22. The wireless headphone as claimed in claim 18, wherein said sound source is one of the devices of Bluetooth module, Bluetooth stereo transceiver, MP3 player and radio.

23. The wireless headphone as claimed in claim 18, further comprising a power supply device coupled to the electric connector in said insertion slot for providing electricity to said sound source or charging battery means of said sound source.

24. The wireless headphone as claimed in claim 23, further comprising a power switch electrically coupled to said power supply device and the electric connector in said insertion slot and adapted to control the connection between said power supply device and the electric connector in said insertion slot.

25. The wireless headphone as claimed in claim 23, wherein said power supply device is disposed in said housing.

26. The wireless headphone as claimed in claim 19, wherein one of said at least one housing has an extension arm that supports said microphone outside said at least one housing.

27. The wireless headphone as claimed in claim 18, wherein the electric connector in said insertion slot is an earphone plug; the electric connector of said sound source is an earphone jack connectable to said earphone plug.

28. The wireless headphone as claimed in claim 18, wherein the electric connector in said insertion slot is female USB connector; the electric connector of said sound source is a male USB connector connectable to said female USB connector.

29. The wireless headphone as claimed in claim 18, wherein the electric connector of said sound source is connectable to the electric connector in said insertion slot through a non-physical connection.

30. A wireless headphone comprising:
a headband;
at least one speaker;
at least one housing coupled to said headband, one of said at least one housing having an insertion slot and an electric connector mounted inside said insertion slot and electrically coupled to said at least one speaker;
a microphone coupled to the electric connector in said insertion slot and adapted to pick up a voice signal and to transmit said voice signal to a sound source; and
wherein the sound source received within said insertion slot and having an electric connector electrically connectable to the electric connector in said insertion slot such that said sound source transmits an audio signal to said at least one speaker.

31. The wireless headphone as claimed in claim 30, wherein said sound source is adapted to wirelessly transmit said voice signal to a wireless communication apparatus.

32. The wireless headphone as claimed in claim 31, wherein said wireless communication apparatus is a cellular phone.

33. The wireless headphone as claimed in claim 30, wherein said sound source is one of the devices of Bluetooth module, Bluetooth stereo transceiver, MP3 player and radio.

34. The wireless headphone as claimed in claim 30, further comprising a power supply device coupled to the electric connector in said insertion slot for providing electricity to said sound source or charging battery means of said sound source.

35. The wireless headphone as claimed in claim 30, wherein the electric connector in said insertion slot is an earphone plug; the electric connector of said sound source is an earphone jack connectable to said earphone plug.

36. The wireless headphone as claimed in claim 30, wherein the electric connector in said insertion slot is female USB connector; the electric connector of said sound source is a male USB connector connectable to said female USB connector.

37. The wireless headphone as claimed in claim 30, wherein the electric connector of said sound source is connectable to the electric connector in said insertion slot through a non-physical connection.
